(19) United States
(12) Patent Application Publication
(10) Pub. No.: US 2015/0330220 A1
(43) Pub. Date: Nov. 19, 2015

(54) METHOD FOR BALANCING THRUST, TURBINE AND TURBINE ENGINE

(71) Applicant: Nuovo Pignone Srl, Florence (IT)

(72) Inventors: Antonio ASTI, Florence (IT); Michele D'ERCOLE, Florence (IT); Giacomo LANDI, Sandvika (NO); Stefano CEI, Florence (IT); Alberto CECCHERINI, Florence (IT)

(21) Appl. No.: 14/652,605

(22) PCT Filed: Dec. 16, 2013
(86) PCT No.: PCT/EP2013/076690

§ 371 Date: Jun. 16, 2015

(30) Foreign Application Priority Data
Dec. 20, 2012 (IT) CO2012A000066

(51) Int. Cl. F01D 3/04; F01D 25/16; F01D 25/24; F01D 5/02

(52) U.S. Cl. CPC F01D 3/04; F01D 5/02; F01D 25/16; F01D 25/24; F05D 2220/30; F05D 2240/54

(57) ABSTRACT

A turbine comprising a rotatable rotor and a pressure chamber; a wall of the pressure chamber is arranged to act on the rotor so that to balance thrust exerted by the rotor when it rotates; a conduit connects the pressure chamber and arranged to a pressure source; a valve associated to the conduit may open and close the conduit; the valve is arranged to open automatically when the pressure upstream of the valve exceeds a first predetermined threshold value; in this way, when the load of the turbine is high excessive thrust is balanced because of the higher pressure in the pressure chamber.

### FIELD OF THE INVENTION

Embodiments of the subject matter disclosed herein generally relate to methods of balancing thrust as well as turbines e turbines engine implementing these methods.

### BACKGROUND ART

When the rotor of a turbine rotates different and considerable thrusts are exerted by the rotor on the stator.

For example, in “Oil & Gas” applications, axial thrust on the bearing of a power gas turbine may easily be in the range from 10,000 N to 100,000 N. Such a power turbine (that may be called “low-pressure turbine” are typically located downstream of a compressor; a turbine (that may be called “high-pressure turbine” is often connected mechanically to the compressor downstream of the compressor and upstream of the high-power turbine; a combustor receives gas from the compressor, realizes combustion and provides gas to the high pressure turbine; this arrangement is usually referred to as “turbine engine”.

It is very difficult and expensive to provide a thrust bearing able to withstand such a high axial thrust.

In order to solve this problem, high-pressure gas is used from the compressor and fed to the power turbine for balancing part of the axial thrust.

A solution of this type is known from U.S. Pat. No. 5,760,289. According to this patent, a valve (42) is associated to a conduit fluidly connecting an inter-stage bleed (39) of a high pressure compressor (14) and a balance piston cavity (32) of a low-pressure turbine (20), i.e. a power turbine; the valve (42) is controlled by a control unit (35); thrust balance pressure transducers (54) are positioned within the balance piston cavity (32) in order to continuously monitor the pressure in the cavity (32); the control unit (35) actively controls the position of the valve (42) in response to an algorithm (58) which continuously calculates the residual load (60) on rotor thrust bearing (28) through certain measured parameters.

Another solution of this type is known also from U.S. Pat. No. 8,092,150. According to this patent, there is an annular cavity (10) upstream of a first disk of a single-turbine system exposed to pressure application with compressed air from the compressor plenum (2), that is down stream of the last stages of the compressor (1), via a pressure line (14) and a control valve (15); two control laws are provided (see FIG. 3 and FIG. 4) linking the axial thrust and the turbine load, but this document does not describe how the control is carried out in practice and it hints at the use of a turbine governor.

Furthermore, a solution similar to this type is known from U.S. Pat. No. 4,864,810. According to this patent, there are balance means in the form of a pressure chamber (56) and means for supplying steam (23, 46) to the chamber (56) to apply a force to walls of the chamber; the chamber is defined, in part, by an inner surface portion of a member connected and rotating with a portion of a thrust bearing (52) whereby pressure force applied on the inner surface in turn applies a tractor force on the thrust bearing. In “dry” operation, the thrust bearing (52) can accommodate the axially directed thrust force; however, it may be desirable to provide a purging type air flow or pressurized air into the chamber (56) conveniently bled upstream in the engine such as from a compressor. Valves (49, 53) associated to flow control means (55) are provided for controlling the flow of both steam and air. This document does not describe the flow control means (55) and it hints at realizing the flow control means as electric or electronic means designed to implement a control law, in particular by sensing or measuring operating conditions or parameters of the engine.

Finally, it is worth clarifying that the inter-stage bleed of a compressor in a turbine engine may be used not only for balancing thrust but also for other purposes such as enhancing the engine performance in certain operating conditions.

A solution of this type is known e.g. from U.S. Pat. No. 8,057,157.

From the above it is clear that the prior art either discloses or hints at using actively controlled valves for connecting the compressor to the turbine in order to achieve thrust balance.

### SUMMARY

Therefore, there is a need for a solution having improved performances in terms of reliability.

In fact, an active control of a valve can provide a more accurate balance of the axial thrust by realizing sophisticated control laws implying also the continuous regulation of the opening of the valve; anyway, the reliability of the active control needs to be guaranteed, which is not an easy task if the reliability required to the whole system is very high as in “Oil & Gas” applications.

As it will be clear from the following, thanks to the present invention, it is possible to use as bearings for the “power turbine” (also called “low-pressure turbine”) ball bearings instead of the commonly used hydrodynamic bearings; ball bearings are simpler and cheaper (both from the construction and maintenance point of view) than hydrodynamic bearings as they do not require drive and control systems.

A first aspect of the present invention is a method of balancing thrust, particularly axial thrust.

According to embodiments thereof, a method is used for balancing thrust in a turbine provided with a rotatable rotor and comprises the steps of: providing a first pressure source outside of said turbine, providing a pressure chamber inside of said turbine, wherein a wall of said pressure chamber acts on said rotor so that to balance thrust exerted by said rotor when it rotates, connecting said first pressure source to said pressure chamber via a first conduit, associating a first valve to said first conduit, said first valve being arranged to open and close said first conduit; wherein said first valve is arranged to open automatically when the pressure upstream of said first valve exceeds a first predetermined threshold value.

A second aspect of the present invention is a turbine, particularly a gas turbine.

According to embodiments thereof, a turbine comprises: a rotatable rotor, a pressure chamber, wherein a wall of said pressure chamber is arranged to act on said rotor so that to balance thrust exerted by said rotor when it rotates, a first conduit connected to said pressure chamber and arranged to be connected to a first pressure source, a first valve associated to said first conduit and arranged to open and close said first conduit; wherein said first valve is arranged to open automatically when the pressure upstream of said first valve exceeds a first predetermined threshold value.

A third aspect of the present invention is a turbine engine, particularly a gas turbine engine.

According to embodiments thereof, a turbine engine comprises the cascade connection of a compressor and a turbine downstream of said compressor, wherein said turbine has at least the technical features as set out above, and wherein said compressor is used as a pressure source for balancing thrust in said turbine.

### BRIEF DESCRIPTION OF DRAWINGS

The accompanying drawings, which are incorporated herein and constitute a part of the specification, illustrate embodiments of the present invention and, together with the description, explain these embodiments. In the drawings:

FIG. 1 shows very schematically an embodiment of a gas turbine engine according to the present invention,

FIG. 2 shows schematically a cross-section of an embodiment of a gas turbine according to the present invention that is part of the turbine engine of FIG. 1,

FIG. 3 shows a detail of FIG. 2,

FIG. 4 shows a schematic diagram of a first embodiment of the balancing means that are part of the turbine engine of FIG. 1,

FIG. 5 shows a schematic diagram of a second embodiment of the balancing means that may be part of the turbine engine of FIG. 1,

FIG. 6 shows a plot of the thrust balancing pressure versus the power generated in the turbine engine of FIG. 1 using the balancing means of FIG. 4, and

FIG. 7 shows a plot of the thrust on bearing versus the power generated in the turbine engine of FIG. 1 using the balancing means of FIG. 4.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

It is to be noted that in the accompanying drawings sometimes sizes have been exaggerated for the sake of clarity; in other words they are not perfectly in scale between each other.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

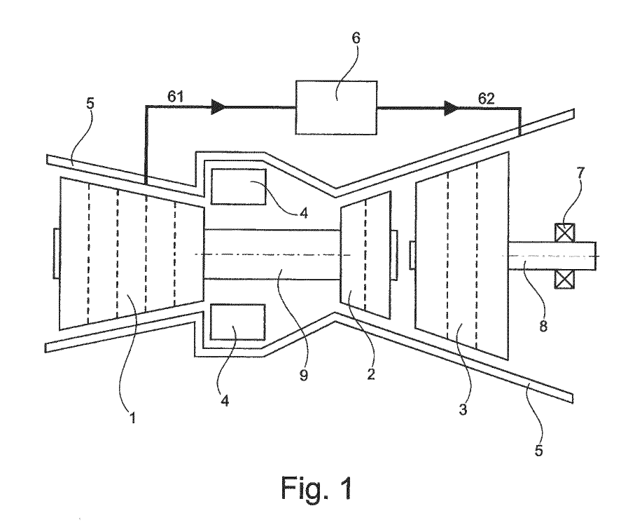

The gas turbine engine of FIG. 1 comprises an axial five-stages compressor 1, an axial two-stages high-pressure (being also low-power) gas turbine 2, an axial three-stages low-pressure (being also high-power) gas turbine 3, a combustor 4; all these components are housed inside a casing 5 of the whole turbine engine. The compressor 1 and the low-power turbine 2 have a common shaft 9 and the high-power turbine 3 has its one shaft 8 (separate and independent from the other shaft). In FIG. 1, a bearing 7 of the shaft 8 is also shown in order to describe the present invention, even if other bearings are necessary in such a solution; it is to be noted that the bearing 7 is able to withstand a certain limited axial thrust.

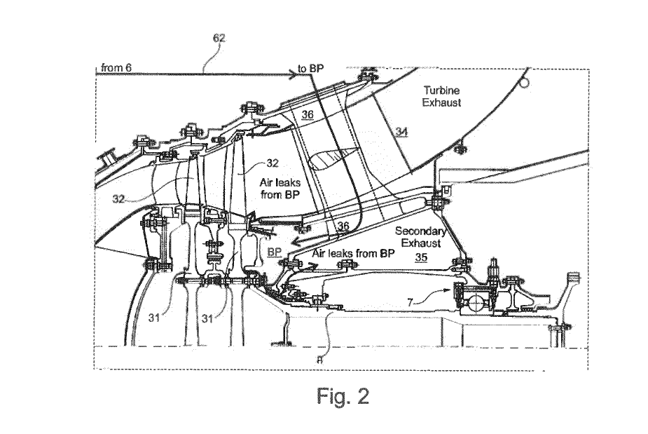

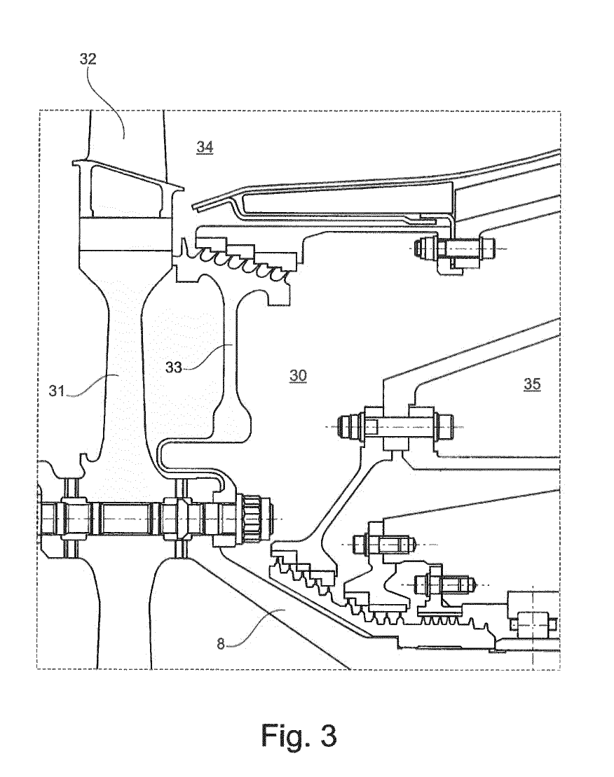

In order to balance excessive axial thrust exerted by the rotor of turbine 3 on e.g. bearing 7, the gas turbine engine of FIG. 1 comprises balancing means 6, being an assembly of one or more valves and one or more orifices, a pipe (specifically a manifold) 61 connecting an inlet of the balancing means 6 to a bleed of compressor 1, and a pipe (specifically a manifold) 62 connecting an outlet of the balancing means 6 to a pressure chamber (not shown in FIG. 1—see element 30/BP in FIG. 2 and FIG. 3) of the high-power turbine 3.

According to the present invention and with reference to the embodiment of FIG. 1: a first pressure source is provided outside of the turbine 3 (in the embodiment the first pressure source is the compressor 1, in particular one stage of the compressor 1); a pressure chamber (not shown in FIG. 1—see element 30/BP in FIG. 2 and FIG. 3) is provided inside of the turbine 3; a wall of the pressure chamber is arranged to act on the rotor of the turbine 3 so that to balance thrust exerted on e.g. bearing 7 by the rotor when it rotates; the first pressure source is connected to the pressure chamber via a first conduit; a first valve is associated to the first conduit so to open and close the first conduit.

The first valve is arranged to open automatically when the pressure upstream of the first valve exceeds a first predetermined threshold value; therefore, the first valve is an “automatic valve” in the sense that its opening and its closing is not determined by an outside control, for example an electrical or electronic control.

In an embodiment, in a gas turbine engine, its internal compressor may be used as pressure source for thrust balancing.

In an embodiment, such an “automatic valve” is a relatively simple purely mechanic and hydraulic component and consists a mechanical valve having a mechanic control member for its opening/closing and a hydraulic actuator having a mechanic actuation member; the hydraulic actuator is hydraulically connected to the above mentioned first conduit upstream of the valve and the mechanic actuation member is mechanically connected to the mechanic control member.

In an embodiment, the first valve is arranged so that to be completely closed when the pressure upstream the first valve is (slightly) smaller than the first predetermined threshold value, and to be completely opened when the pressure upstream the first valve is (slightly) greater than the first predetermined threshold value. In fact, a steep, even if gradual, transition makes the solution precise and simple; while, an abrupt transition is to be avoided.

In an embodiment, along the above mentioned first conduit there is a first orifice (in an embodiment, downstream of the first valve) so that to choke the first conduit; the first orifice is sized so that to establish a choked flow inside the first conduit; in this way, the mass flow rate along the first conduit depends only on the pressure at the begin of the first conduit (e.g. where it is connected to the compressor) and not on the pressure at the end of the first conduit (e.g. where it is connected to the turbine).

According to the present invention and with reference to an embodiment different from that of FIG. 1: a second pressure source is additionally provided outside of the turbine 3; a pressure chamber (not shown in FIG. 1) is provided inside of the turbine 3; a wall of the pressure chamber is arranged to act on the rotor of the turbine 3 so that to balance thrust exerted on the bearing 7 by the rotor when it rotates; the second pressure source is connected to the pressure chamber via an additional second conduit; a second valve is additionally associated to the second conduit so to open and close the second conduit.

The second valve is arranged to open automatically when the pressure upstream of the second valve exceeds a second predetermined threshold value; therefore, the second valve is an “automatic valve” in the sense that its opening and its closing is not determined by an outside control, for example an electrical or electronic control.

In an embodiment, such an “automatic valve” is a relatively simple purely mechanic and hydraulic component and consists a mechanical valve having a mechanic control member for its opening/closing and a hydraulic actuator having a mechanic actuation member; the hydraulic actuator is hydraulically connected to the above mentioned second conduit upstream of the valve and the mechanic actuation member is mechanically connected to the mechanic control member.

In an embodiment, the second valve is arranged so that to be completely closed when the pressure upstream the second valve is (slightly) smaller than the second predetermined threshold value, and to be completely opened when the pressure upstream the second valve is (slightly) greater than the second predetermined threshold value. In fact, a steep, even if gradual, transition makes the solution precise and simple; while, an abrupt transition is to be avoided.

In an embodiment, along the above mentioned second conduit there is a second orifice (in an embodiment, downstream of the first valve) so that to choke the second conduit; the second orifice is sized so that to establish a choked flow inside the second conduit; in this way, the mass flow rate along the second conduit depends only on the pressure at the begin of the second conduit (e.g. where it is connected to the compressor) and not on the pressure at the end of the second conduit (e.g. where it is connected to the turbine).

According to the present invention and with reference to the embodiment of FIG. 1: a third pressure source is additionally provided outside of said turbine, the third pressure source is connected to the pressure chamber via a third conduit.

In an embodiment, along the above mentioned third conduit there is a third orifice so that to choke the third conduit; the third orifice is sized so that to establish a choked flow inside the third conduit; in this way, the mass flow rate along the third conduit depends only on the pressure at the begin of the third conduit (e.g. where it is connected to the compressor) and not on the pressure at the end of the third conduit (e.g. where it is connected to the turbine).

Although the above description refers to three pressure sources, they may correspond to only two pressure sources or to only one pressure source (as in the case of FIG. 1); in an embodiment, a stage of a compressor may be used as pressure source. When there is a compressor comprising a plurality of cascaded stages (as for example in FIG. 1), the outlet of one predetermined stage, an intermediate stage in an embodiment, of said plurality of stages may be used as a pressure source for the pressure chamber. Depending on the application, the outlets of different stages may be used as different pressure sources.

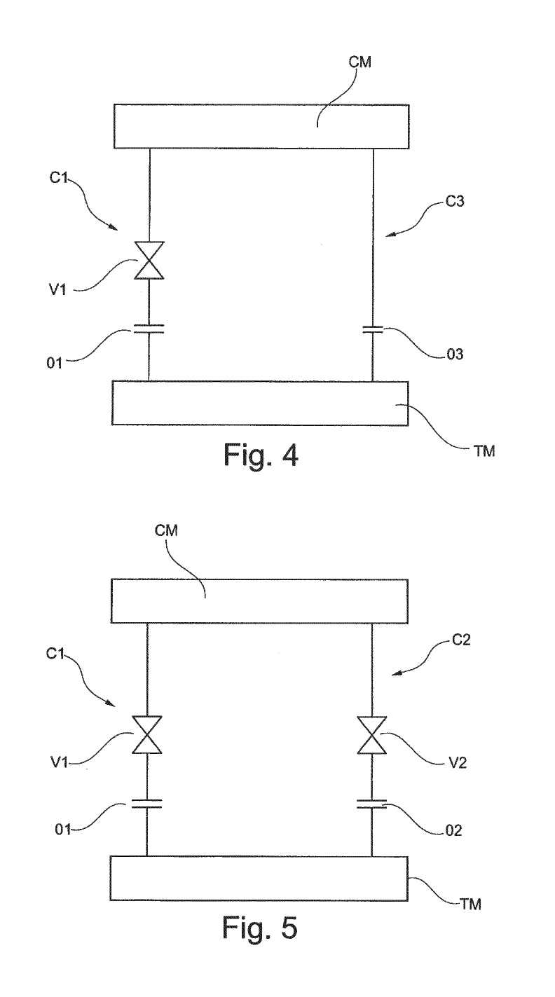

In the embodiment of FIG. 4 (simple and effective), a manifold CM connected to the compressor corresponds to pipe 61 in FIG. 1 and a manifold TM connected to the turbine corresponds to pipe 62 of FIG. 1; the balancing means 6 in FIG. 1 correspond to a first conduit C1 and a third conduit C3; the first conduit C1 is connected between manifold CM and manifold TM and comprises a first valve V1 and a first orifice O1; the third conduit C3 is connected between manifold CM and manifold TM and comprises a third orifice O3.

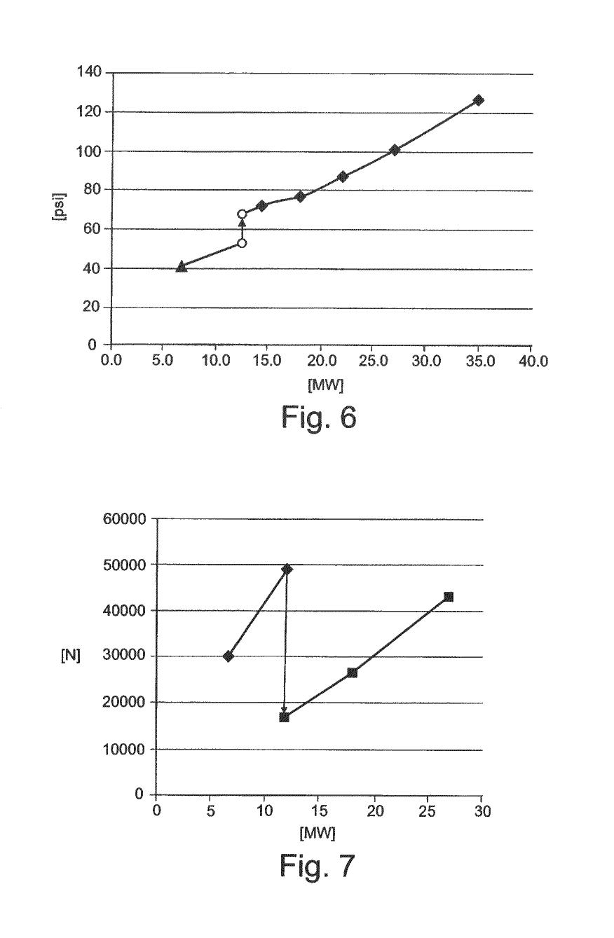

FIG. 6 shows a plot of the thrust balancing pressure versus the power generated in the turbine engine of FIG. 1 using the balancing means of FIG. 4 connected to the eighth stage of an eleven stage compressor. When the power is below approx. 12 MW, there is a gas flow through the third conduit C3 and a certain pressure is provide to the pressure chamber for balancing thrust—the pressure increases with the power. When the power is approx. 12 MW, the pressure at the output of the stage is approximately 135 psi and the first valve V1 opens. When the power is above approx. 12 MW, there is a gas flow through both the first conduit C1 and the third conduit C3 and a higher pressure is provide to the pressure chamber for balancing thrust—the pressure increases with the power.

FIG. 7 shows a plot of thrust on the bearing 7 versus the power generated in the turbine engine of FIG. 1 using the balancing means of FIG. 4 connected to the eighth stage of an eleven stage compressor. As the power generated in the turbine increases the thrust on bearing 7 increases till a maximum value of about 50,000 N. When the power is approx. 12 MW, the pressure at the output of the stage is approximately 135 psi and the first valve V1 opens and the thrust on bearing 7 decreases to about 17,000 N. When the power increases above approx. 12 MW, the thrust on bearing 7 increases starting from about 17,000 N. Therefore bearing 7 is designed to withstand an axial thrust of about only 50,000 N thanks to the use of two conduits one of which being selectively and automatically opened.

When designing the switching pressure of the balancing means and the characteristics of the conduits, the valve and the orifices, it is important to avoid “inversion” of the thrust on the bearing; in other words, the design should be such as to have at least a small positive thrust to be balanced mechanically by the bearing as in FIG. 7.

In the embodiment of FIG. 5 (a bit less simple and a bit more effective), a manifold CM connected to the compressor corresponds to pipe 61 in FIG. 1 and a manifold TM connected to the turbine corresponds to pipe 62 of FIG. 1; the balancing means 6 in FIG. 1 correspond to a first conduit C1 and a second conduit C2; the first conduit C1 is connected between manifold CM and manifold TM and comprises a first valve V1 and a first orifice O1; the second conduit C2 is connected between manifold CM and manifold TM and comprises a second valve V2 and a second orifice O2. In this case, the threshold of the first valve V1 should be different from the threshold of the second valve V2 and the two different threshold may be designed so to have a good thrust balance throughout the operating range of the turbine and so that to limit the maximum thrust on the baring.

It is clear from the above that the number of conduits, valves and orifices may be vary from application to application; also the number of bleeds from the compressor may vary and be greater than one (in FIG. 1 only one bleed is provided); anyway, it is important not to increase excessively the complexity of the balancing arrangement.

In the following reference will be made to FIG. 1 and especially to FIG. 2 and FIG. 3.

Turbine 3 comprises: a rotatable rotor with a plurality of stages each comprising a rotor disk 31 and a plurality of rotor blades 32 and a rotor disk 31 supporting the blades 31, a pressure chamber 30 (labeled also BP in the FIG. 2), wherein a wall 33 of the pressure chamber 30 is arranged to act on the rotor so that to balance the axial thrust exerted by the rotor when it rotates, a first conduit C1 connected to the pressure chamber 30 and arranged to be connected to a first pressure source CM, a first valve V1 associated to said first conduit and arranged to open and close said first conduit C1; the first valve V1 (in an embodiment, an automatic valve as explained above) is arranged to open automatically when the pressure upstream of the first valve V1 exceeds a first predetermined threshold value.

The wall 33 corresponds to the wall of a rotating drum connected fixedly to the rotor disk 31 of the last stage of the turbine 3; therefore, the pressure in the pressure chamber acts indirectly on the rotor of the turbine 3 through the drum that acts as a “balance piston”. It is to be noted that the drum comprise an elastic element (shown as a U-shaped horizontally-arranged element) for compensating radial deformations of the rotor (in particular the rotor disk) and drum due to heat and/or centrifugal force.

As it is apparent in FIG. 2, the air enters the pressure chamber 30 (labeled also BP in the FIG. 2) and leaks out of it through two seals (in particular two labyrinth-type seals); on one side it goes to the turbine main exhaust 34; on the other side it goes to a secondary exhaust 35 that is used just to discharge this air.

According to an embodiment shown in the figures, the bearing is a ball bearing that, anyway, is able to withstand and balance part of the axial thrust exerted by the rotor; therefore, bearing 7 is a thrust bearing.

According to an embodiment shown in the figures, the high-power turbine is provided with a plurality of cascaded stages, and the thrust bearing is located downstream of the last stage of the plurality of cascaded stages.

In an embodiment, the first conduit and/or the second conduit and/or the third conduit for balancing thrust may be provided outside of the turbine or turbine engine, in particular outside of the casing of the whole turbine engine.

In order to feed the pressurized gas flow for thrust balance the first conduit and/or the second conduit and/or the third conduit may, in an embodiment, pass through the exhaust of the turbine, particularly the high-power turbine, and is externally aerodynamically shaped; in the embodiment of FIG. 1 and FIG. 4, the first conduit and the third conduit join into a single pipe 62 (actually a manifold) and it is this single pipe that pass through the exhaust; this is shown in FIG. 6, wherein the exhaust is labeled 34 and the end-part of pipe 62 passing through the exhaust is labeled 36.

In some embodiments, the first and/or second and/or third conduits are integrated so to have a single inlet and a single outlet; this means using a single pressure source and a single pressure chamber.

A turbine according to an embodiment of the present invention is in a gas turbine engine; it comprises the cascade connection of a compressor and a turbine downstream of the compressor, as shown e.g. in FIG. 1. The compressor is used as a pressure source for balancing thrust, in particular axial thrust, in the turbine.

This turbine may be a high-pressure turbine and a low-pressure turbine may be provided between the compressor and the high-pressure turbine, as shown e.g. in FIG. 1. In this, case, in an embodiment, the low-pressure turbine and the high-pressure turbine are provided respectively with two shafts, the two shafts being separate and independent.

In general, the compressor comprises a plurality of cascaded stages, and the outlet of at least one predetermined stage of said plurality of stages is used as a pressure source for balancing axial thrust in the turbine.

What is claimed is:

1. A method for balancing thrust in a turbine provided with a rotatable rotor, the method comprising:
providing a first pressure source outside of said turbine;
providing a pressure chamber inside of said turbine, wherein a wall of said pressure chamber acts on said rotor so that to balance thrust exerted by said rotor when it rotates;
connecting said first pressure source to said pressure chamber via a first conduit; and
associating a first valve to said first conduit, said first valve being arranged to open and close said first conduit,
wherein said first valve is arranged to open automatically when the pressure upstream of said first valve exceeds a first predetermined threshold value.

2. The method of claim 1, wherein said first valve is configured to be completely closed when the pressure upstream of said first valve is smaller than said first predetermined threshold value, and to be completely opened when the pressure upstream of said first valve is greater than said first predetermined threshold value.

3. The method of claim 1, further comprising:
associating a first orifice to said first conduit to choke said first conduit,
wherein said first orifice is sized to establish a choked flow inside said first conduit.

4. The method of claim 1, further comprising:
providing a second pressure source outside of said turbine;
connecting said second pressure source to said pressure chamber via a second conduit;
associating a second valve to said second conduit, said second valve being arranged to open and close said second conduit; and
associating a second orifice to said second conduit to choke said second conduit,
wherein said second valve is arranged to open automatically when the pressure upstream of said second valve exceeds a second predetermined threshold value; and
wherein said second orifice is sized to establish a choked flow inside said second conduit.

5. The method of claim 1, further comprising:
providing a third pressure source outside of said turbine; and
connecting said third pressure source to said pressure chamber via a third conduit.

6. A turbine comprising:
a rotatable rotor;
a pressure chamber, wherein a wall of said pressure chamber is arranged to act on said rotor to balance thrust exerted by said rotor when it rotates;
a first conduit connected to said pressure chamber and arranged to be connected to a first pressure source; and
a first valve associated to said first conduit and arranged to open and close said first conduit,
wherein said first valve is arranged to open automatically when the pressure upstream of said first valve exceeds a first predetermined threshold value.

7. The turbine of claim 6, further comprising:
a first orifice associated to said first conduit to choke said first conduit,
wherein said first orifice is sized to establish a choked flow inside said first conduit.

8. The turbine of claim 6, wherein said first automatic valve comprises:
a mechanical valve comprising a mechanical control member for its opening/closing; and
a hydraulic actuator comprising a mechanical actuation member, wherein said hydraulic actuator is hydraulically connected to said first conduit and said mechanical actuation member is mechanically connected to said mechanical control member.

9. The turbine of claim 6, further comprising a bearing, in particular a ball bearing, and wherein part of said thrust exerted by said rotor when it rotates is balanced by said bearing.

10. The turbine of claim 6, further comprising a plurality of cascaded stages, and wherein said thrust bearing is located downstream of the last stage of said plurality of cascaded stages.

11. The turbine of claim 6, wherein said first conduit passes through an exhaust of said turbine and is externally aerodynamically shaped.

12. A turbine engine comprising:
a cascade connection of a compressor; and
a turbine downstream of said compressor, wherein said turbine comprises:
a rotatable rotor;
a pressure chamber, wherein a wall of said pressure chamber is arranged to act on said rotor to balance thrust exerted by said rotor when it rotates;
a first conduit connected to said pressure chamber and arranged to be connected to a first pressure source; and
a first valve associated to said first conduit and arranged to open and close said first conduit,
wherein said first valve is arranged to open automatically when the pressure upstream of said first valve exceeds a first predetermined threshold value,
wherein said compressor is used as a pressure source for balancing thrust in said turbine.

13. The turbine engine of claim 12, wherein said compressor comprises a plurality of cascaded stages, and wherein the outlet of a stage of said plurality of stages is used as a pressure source for balancing thrust in said turbine.

14. The method of claim 2, further comprising:
associating a first orifice to said first conduit to choke said first conduit,
wherein said first orifice is sized to establish a choked flow inside said first conduit.

15. The method of claim 14, further comprising:
providing a second pressure source outside of said turbine;
connecting said second pressure source to said pressure chamber via a second conduit;
associating a second valve to said second conduit, said second valve being arranged to open and close said second conduit; and
associating a second orifice to said second conduit to choke said second conduit,
wherein said second valve is arranged to open automatically when the pressure upstream of said second valve exceeds a second predetermined threshold value; and
wherein said second orifice is sized to establish a choked flow inside said second conduit.

16. The method of claim 15, further comprising:
providing a third pressure source outside of said turbine; and
connecting said third pressure source to said pressure chamber via a third conduit.

17. The turbine of claim 7, wherein said first automatic valve comprises:
a mechanical valve comprising a mechanical control member for its opening/closing; and
a hydraulic actuator comprising a mechanical actuation member, wherein said hydraulic actuator is hydraulically connected to said first conduit and said mechanical actuation member is mechanically connected to said mechanical control member.

18. The turbine of claim 17, further comprising a bearing, in particular a ball bearing, and wherein part of said thrust exerted by said rotor when it rotates is balanced by said bearing.

19. The turbine of claim 18, further comprising a plurality of cascaded stages, and wherein said thrust bearing is located downstream of the last stage of said plurality of cascaded stages.

20. The turbine of claim 19, wherein said first conduit passes through an exhaust of said turbine and is externally aerodynamically shaped.
